(19) United States
(12) Patent Application Publication
(10) Pub. No.: US 2026/0234455 A1
(43) Pub. Date: Aug. 13, 2026

(54) COMPOSITIONS COMPRISING CIS-1,1,1,2,2,5,5,6,6,6-DECAFLUORO-3-HEXENE ((Z)HFO-153-10mczz) AND USES THEREOF

(71) Applicant: THE CHEMOURS COMPANY FC, LLC, WILMINGTON, DE (US)

(72) Inventor: MICHAEL R. FRASER, QUAKERTOWN, PA (US)

(73) Assignee: THE CHEMOURS COMPANY FC, LLC, WILMINGTON, DE (US)

(21) Appl. No.: 19/156,456

(22) PCT Filed: Feb. 15, 2024
(86) PCT No.: PCT/US2024/015909

§ 371 Date: Aug. 14, 2025

Related U.S. Application Data
(60) Provisional application No. 63/446,651, filed on Feb. 17, 2023.

(51) Int. Cl. C09K 5/04

(52) U.S. Cl. CPC C09K 5/04; C09K 2205/126; C09K 2205/32

(57) ABSTRACT

A composition includes cis-1,1,1,2,2,5,5,6,6,6-decafluoro-3-hexene ((Z)HFO-153-10mczz) and at least one additional compound. The (Z)HFO-153-10mczz and the at least one additional compound are present in the composition in amounts effective to form an azeotropic composition or an azeotrope-like composition. A process of coating a surface includes dissolving a coating composition in a carrier fluid to form a solution. The carrier fluid includes (Z)HFO-153-10mczz. The process also includes applying the solution to the surface and removing the carrier fluid from the coating composition to coat the surface with the coating composition. A process of cooling a system includes two-phase immersion cooling the system with a coolant including (Z)HFO-153-10mczz. A process of cleaning a surface includes contacting a composition including (Z)HFO-153-10mczz with the surface.

### TECHNICAL FIELD

The present disclosure relates to azeotrope or azeotrope-like compositions including cis-1,1,1,2,2,5,5,6,6,6-decafluoro-3-hexene ((Z)HFO-153-10mczz), where the additional components are present in the composition in amounts effective to form an azeotropic composition or azeotrope-like composition with the (Z)HFO-153-10mczz. The compositions described herein may be useful, for example, in precision cleaning and heat transfer applications and as carrier fluids.

### BACKGROUND

Non-flammable hydrofluorocarbon (HFC) compounds and blends have been used extensively in carrier fluids, precision cleaning, and heat transfer operations to provide non-flammable properties and an improved worker safety profile for critical applications in the electronics, aviation, and defense industries. However, these highly stable HFC-based materials are coming under increasing scrutiny due to their high global warming potential (GWP). Fluoroolefins and hydrofluoroolefins (HFOs) have been increasingly evaluated as HFC replacements due to a low atmospheric lifetime and thus a lower GWP.

In a hard disk drive (HDD), information is stored in a magnetic layer on a disk medium. The information stored in the magnetic layer is accessed using sensors on a magnetic head that reads and writes data as the disk rotates rapidly. The magnetic layer is protected by a lubricant coating, typically a functionalized, straight-chain perfluoropolyether (PFPE)-based coating with alcohol or diol end groups that promote surface adhesion to the disk.

To improve the signal to noise ratio and density of information stored, it is desirable to minimize the coating thickness to reduce the flying height of the magnetic head, which is the distance between the magnetic layer with the sensors on the magnetic head, while maintaining adequate lubrication and coating uniformity.

Perfluorocarbon (PFC) compounds, HFCs, and hydrofluoroether (HFE) compounds have been commonly used as carrier fluids for the deposition of these functionalized PFPE coatings. While these solvents may have adequate solubility for most PFPE-based lubricants, the hydroxyl or diol end groups on common HDD lubricants like Fomblin™ ZDol (Solvay S. A., Brussels, Belgium; Formula (1)), Fomblin™ Z-Tetraol (Solvay S. A.; Formula (2)), or Moresco D-40H (Moresco Corporation, Kobe, Japan; Formula (3)) can pose challenges with coating uniformity.

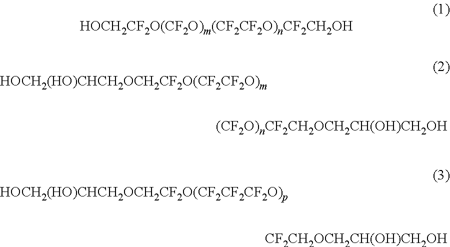

In non-polar solvent systems, the intermolecular hydrogen bonding between PFPE molecules can remain unperturbed, even when solubilized, leaving fewer —OH end groups available for disk adhesion and poor coating uniformity. For this reason, more polar fluorinated solvents like the HFC Vertrel™ XF (The Chemours Company FC, LLC, Wilmington, DE; 2,3-dihydrodecafluropentane; Formula (4)) have been more successfully deployed, especially for thinner coatings, as it can disrupt the hydrogen bonding and disperse —OH groups for better adhesion than the less polar PFCs and HFEs.

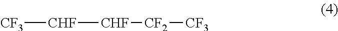

Vertrel™ XF, however, has a GWP of 1650 and is subject to global phase-down, so there is a need for polar, non-flammable fluorinated solvents with low global warming potential.

### SUMMARY

The present disclosure provides, inter alia, a composition, comprising:
i) cis-1,1,1,2,2,5,5,6,6,6-decafluoro-3-hexene ((Z)HFO-153-10mczz); and
ii) at least one additional compound;
wherein the (Z)HFO-153-10mczz and the at least one additional compound are present in the composition in amounts effective to form an azeotropic composition or an azeotrope-like composition.

The present disclosure also provides a process of coating a surface, comprising:
dissolving a coating composition in a carrier fluid, the carrier fluid comprising cis-1,1,1,2,2,5,5,6,6,6-decafluoro-3-hexene ((Z)HFO-153-10mczz), to form a solution;
applying the solution to the surface; and
removing the carrier fluid from the coating composition to coat the surface with the coating composition.

A process for cooling an electrical component comprising at least partially immersing an electrical component in a working fluid; and transferring heat from the electrical component using the working fluid; wherein the working fluid comprises cis-1,1,1,2,2,5,5,6,6,6-decafluoro-3-hexene ((Z)HFO-153-10mczz).

The present disclosure yet further provides a process of cleaning a surface, comprising contacting a composition with said surface, the composition comprising cis-1,1,1,2,2,5,5,6,6,6-decafluoro-3-hexene ((Z)HFO-153-10mczz).

Unless otherwise defined, all technical and scientific terms used herein have the same meaning as commonly understood by one of ordinary skill in the art to which this invention belongs. Methods and materials are described herein for use in the present invention; other, suitable methods and materials known in the art can also be used. The materials, methods, and examples are illustrative only and not intended to be limiting. All publications, patent applications, patents, sequences, database entries, and other references mentioned herein are incorporated by reference in their entirety. In case of conflict, the present specification, including definitions, will control.

The various aspects and embodiments of the invention can be used alone or in combinations with each other. Other features and advantages of the present invention will be apparent from the following more detailed description of the preferred embodiment which illustrates, by way of example, the principles of the invention.

### BRIEF DESCRIPTION OF THE DRAWINGS

FIG. 1 shows the boiling points of binary mixtures of (Z)1,1,1,2,2,5,5,6,6,6-decafluoro-3-hexene ((Z)HFO-153-10mczz) and trans-1,2-dichloroethylene (t-DCE) at atmospheric pressure.

FIG. 2 shows the boiling points of binary mixtures of (Z)HFO-153-10mczz and perfluoroheptene (PFH) at atmospheric pressure.

FIG. 3 shows the boiling points of binary mixtures of (Z)HFO-153-10mczz and ethanol at atmospheric pressure.

FIG. 4 shows the boiling points of binary mixtures of (Z)HFO-153-10mczz and n-propanol at atmospheric pressure.

FIG. 5 shows the boiling points of binary mixtures of (Z)HFO-153-10mczz and isopropanol at atmospheric pressure.

### DETAILED DESCRIPTION

Disclosed are compositions including (Z)1,1,1,2,2,5,5,6,6,6-decafluoro-3-hexene ((Z)HFO-153-10mczz). Azeotropic compositions comprising (Z)HFO-153-10mczz for cleaning, carrier fluid, and heat transfer applications are also disclosed.

(Z)HFO-153-10mczz has the chemical structure shown in Formula (5):

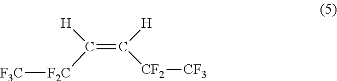

The present disclosure provides new binary and ternary azeotropic and azeotrope-like compositions comprising hydrofluorocarbon mixtures. These compositions have utility in many of the applications formerly served by chlorofluorocarbon (CFC) compounds. The compositions of the present disclosure possess some or all of the desired properties of little or no environmental impact and the ability to dissolve oils, greases, and/or fluxes.

### Definitions and Abbreviations

As used herein, the terms “comprises,” “comprising,” “includes,” “including,” “has,” “having” or any other variation thereof, are intended to cover a non-exclusive inclusion. For example, a process, method, article, or apparatus that comprises a list of elements is not necessarily limited to only those elements but may include other elements not expressly listed or inherent to such process, method, article, or apparatus. Further, unless expressly stated to the contrary, “or” refers to an inclusive or and not to an exclusive or. For example, a condition A or B is satisfied by any one of the following: A is true (or present) and B is false (or not present), A is false (or not present) and B is true (or present), and both A and B are true (or present).

As used herein, the term “consisting essentially of” is used to define a composition or method that includes materials, steps, features, components, or elements, in addition to those literally disclosed provided that these additional included materials, steps, features, components, or elements do not materially affect the basic and novel characteristic(s) of the claimed invention, especially the mode of action to achieve the desired result of any of the processes of the present invention. The term “consists essentially of” or “consisting essentially of” occupies a middle ground between “comprising” and “consisting of”.

Also, use of “a” or “an” are employed to describe elements and components described herein. This is done merely for convenience and to give a general sense of the scope of the invention. This description should be read to include one or at least one and the singular also includes the plural unless it is obvious that it is meant otherwise.

As used herein, the term “about” is meant to account for variations due to experimental error (e.g., plus or minus approximately 10% of the indicated value). All measurements reported herein are understood to be modified by the term “about”, whether or not the term is explicitly used, unless explicitly stated otherwise.

As used herein, the term “atmospheric pressure” refers to a pressure of about 101 MPa.

As used herein, the term “% isomerically pure” refers to the amount of an isomeric compound, by weight, compared to the total amount, by weight, of the isomeric compound and its isomer.

When an amount, concentration, or other value or parameter is given as either a range, preferred range or a list of upper preferable values and/or lower preferable values, this is to be understood as specifically disclosing all ranges formed from any pair of any upper range limit or preferred value and any lower range limit or preferred value, regardless of whether ranges are separately disclosed. Where a range of numerical values is recited herein, unless otherwise stated, the range is intended to include the endpoints thereof, and all integers and fractions within the range.

As recognized in the art, an azeotropic composition is an admixture of two or more different components which, when in liquid form and (1a) under a given constant pressure, will boil at a substantially constant temperature, which temperature may be higher or lower than the boiling temperatures of the individual components, or (1 b) at a given constant temperature, will boil at a substantially constant pressure, which pressure may be higher or lower than the boiling pressure of the individual components, and (2) will boil at substantially constant composition, which phase compositions, while constant, are not necessarily equal (see, e.g., M. F. Doherty and M. F. Malone, Conceptual Design of Distillation Systems, McGraw-Hill (New York), 2001, 185).

A homogeneous azeotrope, in which a single vapor phase is in equilibrium with a single liquid phase, has, in addition to properties (1a), (1b), and (2) above, the composition of each component is the same in each of the coexisting equilibrium phases. The general term “azeotrope” is a commonly used alternative name for a homogeneous azeotrope.

As used herein, an “azeotrope-like” composition refers to a composition that behaves like an azeotropic composition (i.e., has constant boiling characteristics or a tendency not to fractionate upon boiling or evaporation). Hence, during boiling or evaporation, the vapor and liquid compositions, if they change at all, change only to a minimal or negligible extent. In contrast, the vapor and liquid compositions of non-azeotrope-like compositions change to a substantial degree during boiling or evaporation.

As used herein, the terms “azeotrope-like” or “azeotrope-like behavior” refer to compositions that exhibit dew point pressure and bubble point pressure with virtually no pressure differential. In some embodiments, the difference in the dew point pressure and bubble point pressure at a given temperature is 3% or less. In some embodiments, the difference in the bubble point and dew point pressures is 5% or less.

### Azeotrope and Azeotrope-Like Compositions

The present disclosure provides a composition, comprising:
i) cis-1,1,1,2,2,5,5,6,6,6-decafluoro-3-hexene ((Z)HFO-153-10mczz); and
ii) at least one additional compound;
wherein the (Z)HFO-153-10mczz and the at least one additional compound are present in the composition in amounts effective to form an azeotropic composition or an azeotrope-like composition.

In some embodiments, the (Z)HFO-153-10mczz is at least 99% isomerically pure, by weight, such as, for example, at least 99.5% pure. In some embodiments, the composition includes less than 1% trans-1,1,1,2,2,5,5,6,6,6-decafluoro-3-hexene ((E)HFO-153-10mczz), by weight of the composition, such as, for example, less than 0.5% (E)HFO-153-10mczz or less than 0.1% (E)HFO-153-10mczz.

In some embodiments, the ratio of (Z)HFO-153-10mczz to (E)HFO-153-10mczz in the composition is at least 99:1, by weight.

In some embodiments, the composition is substantially free of (E)HFO-153-10mczz.

In some embodiments, the (Z)HFO-153-10mczz and the at least one additional compound are at least 98%, by weight of the composition.

In some embodiments, the (Z)HFO-153-10mczz and the at least one additional compound are at least 99%, by weight of the composition.

In some embodiments, the composition consists essentially of the (Z)HFO-153-10mczz and the at least one additional compound.

In some embodiments, the composition consists of the (Z)HFO-153-10mczz and the at least one additional compound.

In some embodiments, the composition is a binary azeotrope.

In some embodiments, the additional compound includes trans-1,2-dichloroethylene (t-DCE), perfluoroheptene, ethanol, n-propanol, isopropanol, or a combination thereof.

In some embodiments, the composition has a boiling point of about 62° C. to about 70° C. at a pressure of about 101 kPa.

In some embodiments, the additional compound includes t-DCE.

In some embodiments, the composition consists essentially of (Z)HFO-153-10mczz and t-DCE.

In some embodiments, the composition consists of (Z)HFO-153-10mczz and t-DCE.

In some embodiments, the composition includes about 17% to about 49% (Z)HFO-153-10mczz and about 51 to about 83 weight percent t-DCE, by weight of the composition.

In some embodiments, the composition has a boiling point in the range of about 43.5° C. to about 44.5° C. at a pressure of about 101 kPa.

In some embodiments, the composition includes about 24% to about 33% (Z)HFO-153-10mczz and about 67% to about 76% t-DCE, by weight of the composition.

In some embodiments, the composition has a boiling point in the range of about 43.5° C. to about 43.7° C. at a pressure of about 101 kPa.

In some embodiments, the additional compound includes perfluoroheptene (PFH).

In some embodiments, the composition consists essentially of (Z)HFO-153-10mczz and PFH.

In some embodiments, the composition consists of (Z)HFO-153-10mczz and PFH.

In some embodiments, the composition includes about 33% to about 52% (Z)HFO-153-10mczz and about 48% to about 67% PFH, by weight of the composition.

In some embodiments, the composition has a boiling point in the range of about 67.4° C. to about 67.6° C. at a pressure of about 101 kPa.

In some embodiments, the additional compound includes ethanol.

In some embodiments, the composition consists essentially of (Z)HFO-153-10mczz and ethanol.

In some embodiments, the composition consists of (Z)HFO-153-10mczz and ethanol.

In some embodiments, the composition includes about 71% to about 95% (Z)HFO-153-10mczz and about 5% to about 29% ethanol, by weight of the composition.

In some embodiments, the composition has a boiling point in the range of about 62.9° C. to about 63.8° C. at a pressure of about 101 kPa.

In some embodiments, the composition includes about 82% to about 90% (Z)HFO-153-10mczz and about 10% to about 18% ethanol, by weight of the composition.

In some embodiments, the composition has a boiling point in the range of about 62.9° C. to about 63.1° C. at a pressure of about 101 kPa.

In some embodiments, the additional compound includes n-propanol.

In some embodiments, the composition consists essentially of (Z)HFO-153-10mczz and n-propanol.

In some embodiments, the composition consists of (Z)HFO-153-10mczz and n-propanol.

In some embodiments, the composition includes about 82 to about 98.4% (Z)HFO-153-10mczz and about 1.6% to about 18% n-propanol, by weight of the composition.

In some embodiments, the composition has a boiling point in the range of about 68.7° C. to about 69.6° C. at a pressure of about 101 kPa.

In some embodiments, the composition includes about 90.2% to about 97.4% (Z)HFO-153-10mczz and about 2.6% to about 9.8% n-propanol, by weight of the composition.

In some embodiments, the composition has a boiling point in the range of about 68.7° C. to about 69.0° C. at a pressure of about 101 kPa.

In some embodiments, the additional compound includes isopropanol.

In some embodiments, the composition consists essentially of (Z)HFO-153-10mczz and isopropanol.

In some embodiments, the composition consists of (Z)HFO-153-10mczz and isopropanol.

In some embodiments, the composition includes about 76 to about 96% (Z)HFO-153-10mczz and about 4.0% to about 24% isopropanol, by weight of the composition.

In some embodiments, the composition has a boiling point in the range of about 66.4° C. to about 67.4° C. at a pressure of about 101 kPa.

In some embodiments, the composition includes about 81.0% to about 95.0% (Z)HFO-153-10mczz and about 5.0 to about 19% isopropanol, by weight of the composition.

In some embodiments, the composition has a boiling point in the range of about 66.4° C. to about 66.8° C. at a pressure of about 101 kPa.

In some embodiments, the composition is a ternary azeotrope.

In some embodiments, the ternary azeotrope includes (Z)HFO-153-10mczz, t-DCE, and ethanol, n-propanol, or isopropanol.

In some embodiments, the ternary azeotrope includes about 17% to about 35% (Z)HFO-153-10mczz, about 56% to about 79% t-DCE, and about 0.5% to about 15% of the alcohol, by weight of the composition.

In some embodiments, the ternary azeotrope has a boiling point of about 40° C. to about 44° C. at a pressure of about 101 kPa.

In some embodiments, the ternary azeotrope includes (Z)HFO-153-10mczz, t-DCE, and methanol.

In some embodiments, the composition consists essentially of (Z)HFO-153-10mczz, t-DCE, and methanol.

In some embodiments, the composition consists of (Z)HFO-153-10mczz, t-DCE, and methanol.

In some embodiments, the ternary azeotrope includes about 17% to about 34% (Z)HFO-153-10mczz, about 56% to about 78% t-DCE, and about 2% to about 15% methanol, by weight of the composition.

In some embodiments, the ternary azeotrope has a boiling point of about 39.8° C. to about 40.3° C. at a pressure of about 101 kPa.

In some embodiments, the ternary azeotrope includes (Z)HFO-153-10mczz, t-DCE, and ethanol.

In some embodiments, the composition consists essentially of (Z)HFO-153-10mczz, t-DCE, and ethanol.

In some embodiments, the composition consists of (Z)HFO-153-10mczz, t-DCE, and ethanol.

In some embodiments, the ternary azeotrope includes about 19% to about 34% (Z)HFO-153-10mczz, about 60% to about 79% t-DCE, and about 1% to about 7% ethanol, by weight of the composition.

In some embodiments, the ternary azeotrope has a boiling point of about 42.6° C. to about 43.1° C. at a pressure of about 101 kPa.

In some embodiments, the ternary azeotrope includes (Z)HFO-153-10mczz, t-DCE, and isopropanol.

In some embodiments, the composition consists essentially of (Z)HFO-153-10mczz, t-DCE, and isopropanol.

In some embodiments, the composition consists of (Z)HFO-153-10mczz, t-DCE, and isopropanol.

In some embodiments, the ternary azeotrope includes about 19% to about 35% (Z)HFO-153-10mczz, about 63% to about 79% t-DCE, and about 0.5% to about 4% isopropanol, by weight of the composition.

In some embodiments, the ternary azeotrope has a boiling point of about 43.8° C. to about 44.2° C. at a pressure of about 101 kPa.

### Methods of Use

In some embodiments, compositions described herein are useful as carrier fluids. In some embodiments, the carrier fluids aid in the deposition of fluorolubricants, such as, for example, fluorolubricants for hard-disk drives. Accordingly, the present disclosure further provides processes of depositing a fluorolubricant, comprising contacting a composition described herein with said fluorolubricant and transporting said fluorolubricant with said composition to a target location.

In some embodiments, a process of coating a surface include dissolving a coating composition in a carrier fluid of a composition described herein to form a solution. The process further includes applying the solution to the surface and removing the carrier fluid from the coating composition to coat the surface with the coating composition. In some embodiments, the coating composition includes a perfluoropolyether. In some embodiments, the surface is a surface of a disk of a hard disk drive.

In some embodiments, compositions described herein are useful as coolants. In some embodiments, compositions described herein are coolants in two-phase immersion cooling systems. In some embodiments, the two-phase immersion cooling systems are for data centers or electric vehicle batteries. Accordingly, the present disclosure further provides processes for cooling a system, comprising two-phase immersion cooling the system with a composition described herein.

In some embodiments, compositions described herein are useful as degreasers and/or cleaners for precision cleaning and/or industrial cleaning. In some embodiments, compositions described herein are useful for vapor degreasing, aerosol cleaning, and/or cold cleaning. Accordingly, the present disclosure further provides processes of cleaning a surface, comprising contacting a composition described herein with said surface.

The means for contacting a device, surface, or substrate is not critical and may be accomplished, for example, by immersion of the device, surface, or substrate, in a bath containing the composition provided herein, spraying the device, surface, or substrate with the composition provided herein, or wiping the device, surface, or substrate with a material (e.g., a cloth) that has been wet with the composition. Alternatively, a composition provided herein may also be used in a vapor degreasing or defluxing apparatus designed for such residue removal. Such vapor degreasing or defluxing equipment is available from various suppliers such as Forward Technology (a subsidiary of the Crest Group, Trenton, NJ), Trek Industries (Azusa, CA), and Ultronix, Inc. (Hatfield, PA) among others.

In some embodiments, the surface or substrate may be an integrated circuit device, in which case, the residue comprises rosin flux or oil. The integrated circuit device may be a circuit board with various types of components, such as Flip chips, micro ball grid arrays (μBGAs), or Chip scale packaging components. The surface or substrate may additionally be a metal surface such as stainless steel. The rosin flux may be any type commonly used in the soldering of integrated circuit devices, including but not limited to RMA (rosin mildly activated), RA (rosin activated), WS (water soluble), and OA (organic acid). Oil residues include but are not limited to mineral oils, motor oils, and silicone oils.

In some embodiments, compositions described herein are useful in the electronics industry, the aviation industry, and/or the defense industry.

In some embodiments, compositions comprising (Z)HFO-153-10mczz are useful in any or all of the above-mentioned methods of use. In some embodiments, the ratio of (Z)HFO-153-10mczz to (E)HFO-153-10mczz in such compositions is at least 99:1, by weight. In some embodiments, such compositions are substantially free of (E)HFO-153-10mczz. In some embodiments, the (Z)HFO-153-10mczz is at least 98%, by weight of such compositions. In some embodiments, the (Z)HFO-153-10mczz is at least 99%, by weight of such compositions. In some embodiments, such compositions consist essentially of the (Z)HFO-153-10mczz. In some embodiments, such compositions consist of the (Z)HFO-153-10mczz.

### EXAMPLES

The invention will be described in greater detail by way of specific examples. The following examples are offered for illustrative purposes, and are not intended to limit the invention in any manner. Those of skill in the art will readily recognize a variety of non-critical parameters which can be changed or modified to yield essentially the same results.

### Example 1

Fomblin™ T4 PFPE lubricant (Solvay S. A.) contains a PFPE of Formula (2). The solubility of Fomblin™ T4 PFPE lubricant in various solvents was measured to determine their potential suitability in carrier solvents. Vertrel XF, (E)HFO-153-10mczz, (Z)1336mzzZ, MPHE, PFH, (Z)HFO-153-10mczz, and 1,1,1,2-tetrafluoroethyl-2,2,2-trifluoroethyl ether (HFE-347pc-f) were tested. The (Z)HFO-153-10mczz samples used in this and the following Examples contained less than 0.5 wt % (E)HFO-153-10mczz.

A known amount of lubricant was added to each solvent and the mixture was observed for solubility. Observation of phase separation indicated insolubility. The results are shown in Table 1.

TABLE 1
Solubility of Fomblin ™ T4 PFPE lubricant

| Solvent | Solubility |
|---|---|
| Vertrel XF | >3% |
| (E)HFO-153-10mczz | <0.5% |
| (Z)1336mzzZ | >3% |
| MPHE | <0.5% |
| PFH | <0.5% |
| (Z)HFO-153-10mczz | >3% |
| HFE-347pc-f | 1.0% |

(Z)HFO-153-10mczz and (Z)1336mzzZ both provided solubilities greater than 3%, which was also observed for Vertrel XF. The other tested solvents provided solubilities of 1% or less.

### Example 2

An ebulliometer method was used to screen for azeotropic binary mixtures of (Z)HFO-153-10mczz and trans-1,2-dichloroethylene (t-DCE). A known amount of (Z)HFO-153-10mczz was decanted into the ebulliometer and heated to the atmospheric boiling point, which was recorded. A known amount of t-DCE was added, and the boiling point was allowed to equilibrate and was then recorded. This was repeated over a range of binary compositions.

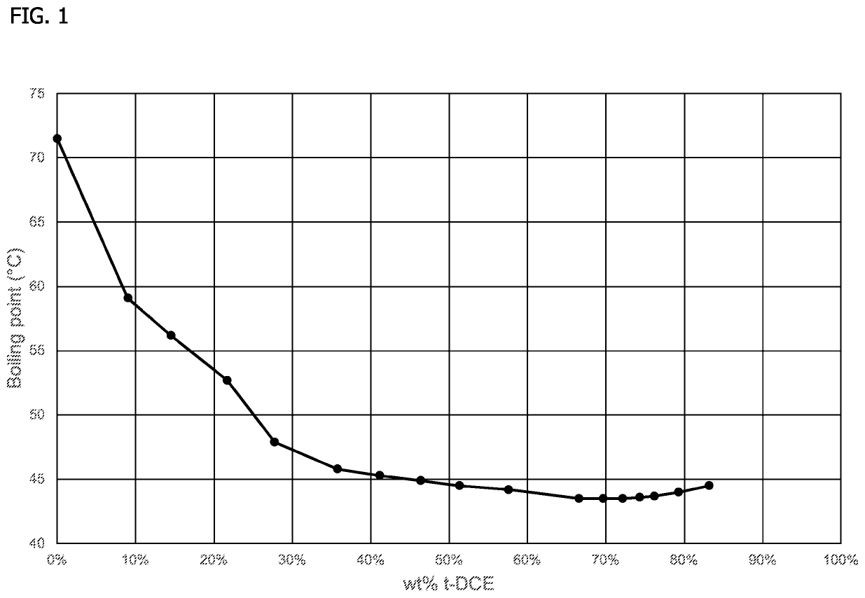

FIG. 1 shows a plot of the boiling point as a function of composition. The binary mixture of (Z)HFO-153-10mczz and t-DCE was azeotropic or azeotrope-like at least over the range of about 51 wt % t-DCE to about 83 wt % t-DCE with a boiling point in the range of about 43.5 to about 44.5° C., alternatively over the range of about 67 wt % t-DCE to about 76 wt % t-DCE with a boiling point in the range of about 43.5 to about 43.7° C., or any value, range, or sub-range therebetween at a pressure of about 101 kPa.

### Example 3

An ebulliometer method was used to screen for azeotropic binary mixtures of (Z)HFO-153-10mczz and PFH. A known amount of (Z)HFO-153-10mczz was decanted into the ebulliometer and heated to the atmospheric boiling point, which was recorded. A known amount of PFH was added, and the boiling point was allowed to equilibrate and was then recorded. This was repeated over a range of binary compositions.

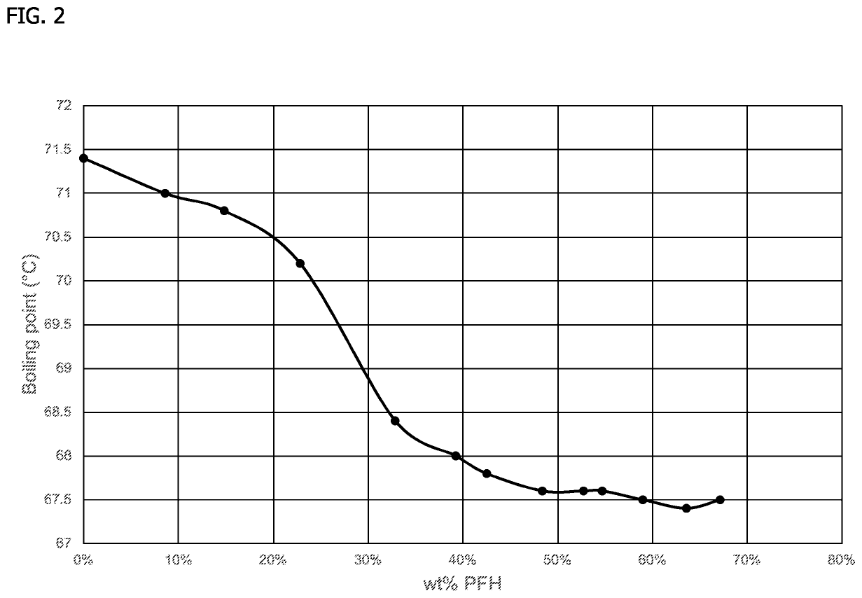

FIG. 2 shows a plot of the boiling point as a function of composition. The binary mixture of (Z)HFO-153-10mczz and PFH was azeotropic or azeotrope-like at least over the range of about 48 wt % PFH to about 67 wt % PFH with a boiling point in the range of about 67.4 to about 67.6° C., or any value, range, or sub-range therebetween at a pressure of about 101 kPa.

### Example 4

An ebulliometer method was used to screen for azeotropic binary mixtures of (Z)HFO-153-10mczz and ethanol. A known amount of (Z)HFO-153-10mczz was decanted into the ebulliometer and heated to the atmospheric boiling point, which was recorded. A known amount of ethanol was added, and the boiling point was allowed to equilibrate and was then recorded. This was repeated over a range of binary compositions.

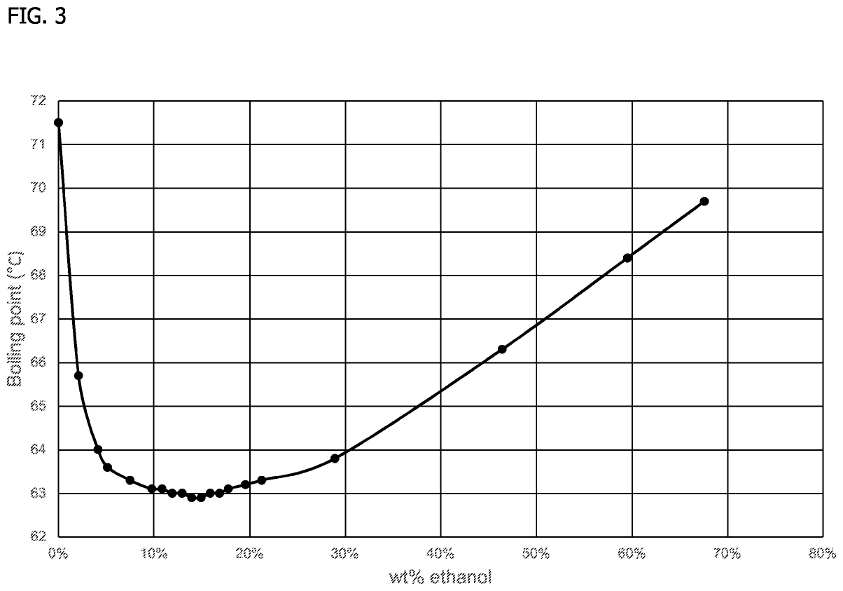

FIG. 3 shows a plot of the boiling point as a function of composition. The binary mixture of (Z)HFO-153-10mczz and ethanol was azeotropic or azeotrope-like at least over the range of about 5 wt % ethanol to about 29 wt % ethanol with a boiling point in the range of about 62.9 to about 63.8° C., alternatively over the range of about 10 wt % ethanol to about 18 wt % ethanol with a boiling point in the range of about 62.9 to about 63.1° C., or any value, range, or sub-range therebetween at a pressure of about 101 kPa.

### Example 5

An ebulliometer method was used to screen for azeotropic binary mixtures of (Z)HFO-153-10mczz and n-propanol. A known amount of (Z)HFO-153-10mczz was decanted into the ebulliometer and heated to the atmospheric boiling point, which was recorded. A known amount of n-propanol was added, and the boiling point was allowed to equilibrate and was then recorded. This was repeated over a range of binary compositions.

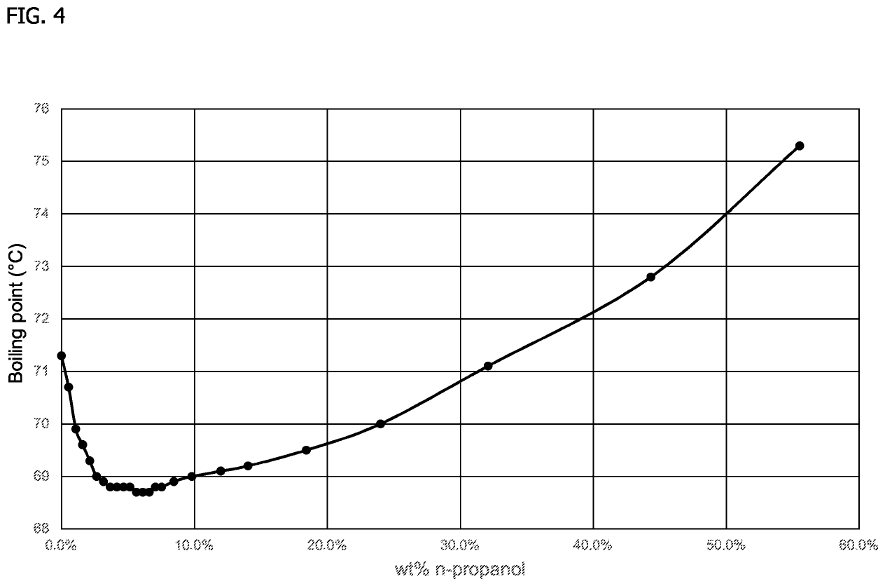

FIG. 4 shows a plot of the boiling point as a function of composition. The binary mixture of (Z)HFO-153-10mczz and n-propanol was azeotropic or azeotrope-like at least over the range of about 1.6 wt % n-propanol to about 18 wt % n-propanol with a boiling point in the range of about 68.7 to about 69.6° C., alternatively over the range of about 2.6 wt % n-propanol to about 9.8 wt % n-propanol with a boiling point in the range of about 68.7 to about 69.0° C., or any value, range, or sub-range therebetween at a pressure of about 101 kPa.

### Example 6

An ebulliometer method was used to screen for azeotropic binary mixtures of (Z)HFO-153-10mczz and isopropanol. A known amount of (Z)HFO-153-10mczz was decanted into the ebulliometer and heated to the atmospheric boiling point, which was recorded. A known amount of isopropanol was added, and the boiling point was allowed to equilibrate and was then recorded. This was repeated over a range of binary compositions.

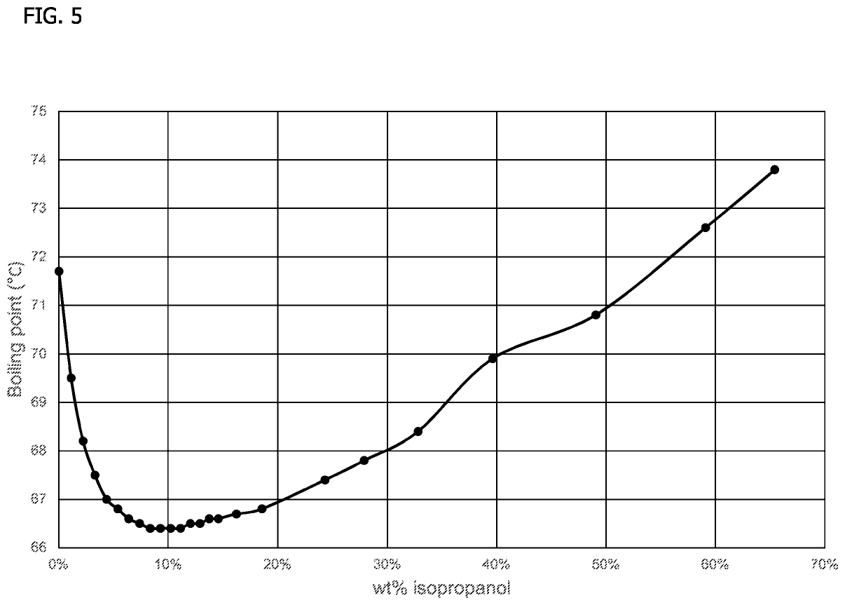

FIG. 5 shows a plot of the boiling point as a function of composition. The binary mixture of (Z)HFO-153-10mczz and isopropanol was azeotropic or azeotrope-like at least over the range of about 4 wt % isopropanol to about 24 wt % isopropanol with a boiling point in the range of about 66.4 to about 67.4° C., alternatively over the range of about 5 wt % isopropanol to about 19 wt % isopropanol with a boiling point in the range of about 66.4 to about 66.8° C., or any value, range, or sub-range therebetween at a pressure of about 101 kPa.

### Example 7

In precision cleaning applications, fluorinated solvents are commonly blended with flammable solvents to form non-flammable, azeotropic mixtures that enhance solubility and cleaning performance toward targeted contaminants. Flammable solvents commonly used in these mixtures include t-DCE and C1-C3 alcohols (methanol, ethanol, n-propanol, isopropanol). Commercially available examples include Novec™ 72DA (3M), Vertrel™ SMT (Chemours), and Vertrel™ SFR (Chemours), but these mixtures contain HFEs and HFCs, which have long atmospheric lifetimes and high global warming potential. There is a need for non-flammable, azeotropic precision cleaning mixtures with high cleaning performance and low global warming potential. However, as shown in Table 2, currently available or under development HFOs have azeotropic properties with t-DCE and alcohols that are not optimized for precision cleaning, as they are either flammable or demonstrate poor cleaning performance with K_{b} values less than 30.

TABLE 2
Ternary Azeotropes

| | | | | | Flash | Boiling | |
|---|---|---|---|---|---|---|---|
| | wt % | wt % | | wt % | point | point | K_{b} |
| HFO | HFO | t-DCE | Alcohol | alcohol | (° C.) | (° C.) | value |
| 1336mzzZ | 78 | 20 | methanol | 2 | none | 27 | 23 |
| 1233zdE | no ternary azeotrope | | | | N/A | N/A | N/A |
| MPHE | 3 | 91 | methanol | 6 | −10 | 46 | >100 |
| MPHE | 3 | 93 | ethanol | 4 | −10 | 46 | >100 |
| MPHE | 3 | 95 | isopropanol | 2 | −10 | 46 | >100 |
| (E)HFO-153-10mczz | 68 | 30 | methanol | 2 | none | 33 | 25 |
| (Z)HFO-153-10mczz | 23 | 71 | methanol | 6 | none | 40 | 80 |
| (Z)HFO-153-10mczz | 25 | 71 | ethanol | 4 | none | 43 | 78 |
| (Z)HFO-153-10mczz | 25 | 73 | isopropanol | 2 | none | 44 | 78 |

In contrast, (Z)HFO-153-10mczz exhibited ternary azeotropic properties with mixtures containing t-DCE and either methanol, ethanol, or isopropyl alcohol, as shown in Table 2. These azeotropes were determined via atmospheric distillation experiments using a 20-plate Vigreux distillation column at a pressure of about 101 kPa.

Identified ternary azeotropes with (Z)HFO-153-10mczz were tested for flammability via Tag closed cup flash point test methods. None of the three azeotropes listed in Table 3 exhibited a flash point, and all were determined to be non-flammable.

Additionally, the Kauri butanol (K_{b}) value for each of these three mixtures was determined via ASTM D1133. As shown by the values listed in Table 2, (Z)HFO-153-10mczz mixtures provide optimized azeotropic mixtures that are non-flammable with a high cleaning power.

### Example 8

Ebulliometer methods were used to determine the azeotropic ranges of ternary mixtures of (Z)HFO-153-10mczz, t-DCE, and methanol. 20 grams of an 80 wt % t-DCE and 20 wt % (Z)HFO-153-10mczz mixture was prepared, loaded into the ebulliometer, and heated to the atmospheric boiling point, and the initial boiling point was recorded. Known amounts of methanol were added to the ebulliometer, and the temperature was allowed to equilibrate, then recorded. This was repeated over the range of compositions listed in Table 3.

TABLE 3
Ternary Mixtures with Methanol Starting from
80 wt % t-DCE and 20 wt % (Z)HFO-153-10mczz

| wt % | wt % (Z)HFO- | wt % | BP |
|---|---|---|---|
| t-DCE | 153-10mczz | methanol | (° C.) |
| 80.0 | 20.0 | 0.0 | 44.0 |
| 79.2 | 19.8 | 1.0 | 41.3 |
| 78.0 | 19.5 | 2.5 | 40.3 |
| 76.9 | 19.2 | 3.8 | 40.0 |
| 75.7 | 18.9 | 5.4 | 39.8 |
| 72.7 | 18.6 | 6.8 | 39.8 |
| 71.6 | 18.2 | 9.1 | 39.9 |
| 69.6 | 17.9 | 10.6 | 40.0 |
| 67.8 | 17.4 | 13.0 | 40.1 |
| 66.1 | 16.9 | 15.3 | 40.3 |
| 63.5 | 16.5 | 17.4 | 40.5 |
| 61.0 | 15.9 | 20.6 | 40.9 |
| 56.7 | 15.2 | 23.8 | 41.3 |
| 53.0 | 14.2 | 29.1 | 42.0 |

The above process was repeated, starting instead with a 65 wt % t-DCE and 35 wt % (Z)HFO-153-10mczz mixture and adding known amounts of methanol. The results are shown in Table 4.

TABLE 4
Ternary Mixtures with Methanol Starting from
65 wt % t-DCE and 35 wt % (Z)HFO-153-10mczz

| wt % | wt % (Z)HFO- | wt % | BP |
|---|---|---|---|
| t-DCE | 153-10mczz | methanol | (° C.) |
| 65.0 | 35.0 | 0.0 | 43.8 |
| 63.5 | 34.2 | 2.2 | 40.3 |
| 61.8 | 33.3 | 5.0 | 39.9 |
| 61.3 | 33.0 | 5.7 | 39.8 |
| 60.6 | 32.6 | 6.8 | 39.8 |
| 60.2 | 32.4 | 7.4 | 39.8 |
| 59.2 | 31.9 | 8.9 | 39.9 |
| 58.4 | 31.5 | 10.1 | 40.0 |
| 56.5 | 30.4 | 13.0 | 40.2 |
| 54.2 | 29.2 | 16.7 | 40.4 |
| 51.2 | 27.6 | 21.3 | 41.1 |
| 48.3 | 26.0 | 25.7 | 42.0 |

As shown in Tables 3 and 4, the ternary mixtures of t-DCE, (Z)HFO-153-10mczz, and methanol were azeotropic or azeotrope-like at least over the range of about 56.5% to 78.0% t-DCE, about 16.9% to about 34.2% (Z)HFO-153-10mczz, and about 2.2% to about 15.3% methanol with a boiling point of about 39.8° C. to 40.3° C.

### Example 9

Ebulliometer methods were used to determine the azeotropic ranges of ternary mixtures of (Z)HFO-153-10mczz, t-DCE, and ethanol. 20 grams of an 80 wt % t-DCE and 20 wt % (Z)HFO-153-10mczz mixture was prepared, loaded into the ebulliometer, and heated to the atmospheric boiling point, and the initial boiling point was recorded. Known amounts of ethanol were added to the ebulliometer, and the temperature was allowed to equilibrate, then recorded. This was repeated over the range of compositions listed in Table 5.

TABLE 5
Ternary Mixtures with Ethanol Starting from
80 wt % t-DCE and 20 wt % (Z)HFO-153-10mczz

| wt % | wt % (Z)HFO- | wt % | BP |
|---|---|---|---|
| t-DCE | 153-10mczz | ethanol | (° C.) |
| 80.0 | 20.0 | 0.0 | 43.5 |
| 79.2 | 19.8 | 0.9 | 43 |
| 78.8 | 19.7 | 1.5 | 42.7 |
| 78.2 | 19.6 | 2.2 | 42.6 |
| 77.9 | 19.5 | 2.7 | 42.7 |
| 77.2 | 19.3 | 3.5 | 42.8 |
| 76.6 | 19.1 | 4.3 | 42.8 |
| 76.0 | 19.0 | 5.0 | 42.9 |
| 74.9 | 18.7 | 6.4 | 43.1 |
| 74.2 | 18.5 | 7.3 | 43.2 |
| 73.5 | 18.4 | 8.1 | 43.3 |
| 72.5 | 18.1 | 9.4 | 43.6 |
| 71.1 | 17.8 | 11.1 | 43.8 |
| 69.6 | 17.4 | 13.0 | 44.3 |
| 68.0 | 17.0 | 15.0 | 44.6 |

The above process was repeated, starting instead with a 65 wt % t-DCE and 35 wt % (Z)HFO-153-10mczz mixture and adding known amounts of ethanol. The results are shown in Table 6.

TABLE 6
Ternary Mixtures with Ethanol Starting from
65 wt % t-DCE and 35 wt % (Z)HFO-153-10mczz

| wt % | wt % (Z)HFO- | wt % | BP |
|---|---|---|---|
| t-DCE | 153-10mczz | ethanol | (° C.) |
| 65.0 | 35.0 | 0.0 | 43.9 |
| 64.5 | 34.8 | 0.7 | 43.4 |
| 63.8 | 34.3 | 1.9 | 43.1 |
| 63.2 | 34.0 | 2.8 | 42.9 |
| 62.3 | 33.5 | 4.2 | 42.9 |
| 61.3 | 33.0 | 5.7 | 43.0 |
| 60.6 | 32.6 | 6.8 | 43.1 |
| 60.0 | 32.3 | 7.7 | 43.3 |
| 58.2 | 31.3 | 10.5 | 43.6 |
| 56.3 | 30.3 | 13.4 | 44.0 |
| 54.7 | 29.4 | 15.9 | 44.5 |
| 52.7 | 28.4 | 19.0 | 45.2 |
| 50.8 | 27.4 | 21.8 | 45.6 |
| 48.7 | 26.2 | 25.0 | 46.2 |

As shown in in Tables 5 and 6, the ternary mixtures of t-DCE, (Z)HFO-153-10mczz, and ethanol were azeotropic or azeotrope-like at least over the range of about 60.6% to about 79.2% of t-DCE, about 18.7% to about 34.3% of (Z)HFO-153-10mczz, and about 0.9% to about 6.8% of ethanol with a boiling point of about 42.6° C. to 43.1° C.

### Example 10

Ebulliometer methods were used to determine the azeotropic ranges of ternary mixtures of (Z)HFO-153-10mczz, t-DCE, and isopropanol. 20 grams of an 80 wt % t-DCE and 20 wt % (Z)HFO-153-10mczz mixture was prepared, loaded into the ebulliometer, and heated to the atmospheric boiling point, and the initial boiling point was recorded. Known amounts of isopropanol were added to the ebulliometer, and the temperature was allowed to equilibrate, then recorded. This was repeated over the range of compositions listed in Table 7.

TABLE 7
Ternary Mixtures with Isopropanol Starting from
80 wt % t-DCE and 20 wt % (Z)HFO-153-10mczz

| wt % | wt % (Z)HFO- | wt % | BP |
|---|---|---|---|
| t-DCE | 153-10mczz | isopropanol | (° C.) |
| 80.0 | 20.0 | 0.0 | 43.9 |
| 79.7 | 19.9 | 0.4 | 43.8 |
| 79.2 | 19.8 | 0.9 | 43.8 |
| 78.9 | 19.7 | 1.4 | 43.8 |
| 78.4 | 19.6 | 2.0 | 43.8 |
| 78.1 | 19.5 | 2.3 | 43.8 |
| 76.9 | 19.2 | 3.8 | 44 |
| 75.3 | 18.8 | 5.9 | 44.5 |
| 73.4 | 18.3 | 8.3 | 44.9 |
| 69.6 | 17.4 | 13.0 | 45.9 |
| 65.2 | 16.3 | 18.5 | 47.1 |
| 60.0 | 15.0 | 25.0 | 48.7 |

The above process was repeated, starting instead with a 65 wt % t-DCE and 35 wt % (Z)HFO-153-10mczz mixture and adding known amounts of isopropanol. The results are shown in Table 8.

TABLE 8
Ternary Mixtures with Isopropanol Starting from
65 wt % t-DCE and 35 wt % (Z)HFO-153-10mczz

| wt % | wt % (Z)HFO- | wt % | BP |
|---|---|---|---|
| t-DCE | 153-10mczz | isopropanol | (° C.) |
| 65.0 | 35.0 | 0.0 | 44 |
| 64.7 | 34.8 | 0.5 | 43.9 |
| 64.4 | 34.7 | 1.0 | 43.9 |
| 64.0 | 34.5 | 1.5 | 44 |
| 63.4 | 34.1 | 2.4 | 44.1 |
| 62.8 | 33.8 | 3.4 | 44.2 |
| 62.2 | 33.5 | 4.4 | 44.4 |
| 61.0 | 32.9 | 6.1 | 44.6 |
| 60.5 | 32.6 | 7.0 | 44.8 |
| 58.8 | 31.6 | 9.6 | 45.3 |
| 57.6 | 31.0 | 11.3 | 45.6 |
| 54.3 | 29.3 | 16.4 | 47 |
| 52.0 | 28.0 | 20.0 | 47.8 |
| 48.1 | 25.9 | 25.9 | 49.5 |
| 44.8 | 24.1 | 31.0 | 51.1 |

As shown in Tables 7 and 8, the ternary mixtures of t-DCE, (Z)HFO-153-10mczz, and isopropanol demonstrated azeotrope-like ranges of about 62.8% to about 79.7% t-DCE, from about 19.2% to about 34.8% (Z)HFO-153-10mczz, and from about 0.4% to about 3.8% isopropanol with a boiling point of about 43.8° C. to about 44.2° C.

### Example 11

A composition containing 68% t-DCE, 28% (Z)1,1,1,2,2,5,5,6,6,6-decafluoro-3-hexene, and 4% EtOH was decanted into a 1000 mL beaker with a condensing coil and heated to the boiling point using a hot plate. Three precleaned 304 stainless steel coupons were weighed on an analytical balance (initial weight). A thin film of the following contaminants were applied to one surface of each coupon and excess was removed with a wipe. Each coupon was then reweighed to determine the soiled weight and subsequently placed in the vapor phase of the boiling composition for ten minutes. The coupons were then removed and allowed to dry and off-gas for ten minutes before reweighing (post cleaning weight) to determine the cleaning effectiveness factor of the solvent blend. Results of the cleaning analysis are shown in Table 1 and the CEF was determined according to Equation 1. The results are shown in Table 9.

$$CEF = ( soiled weight - post cleaning weight ) / ( soiled weight - initial weight ) \qquad Equation 1$$

TABLE 9
Cleaning Effectiveness Factor (CEF)

| | Initial | Soiled | Post - Cleaned | |
|---|---|---|---|---|
| Coupon ID | Weight (g) | Weight (g) | Weight (g) | CEF |
| Mineral Oil | 19.7469 | 19.7488 | 19.7469 | 100.0% |
| Hydraulic | 19.9557 | 19.9593 | 19.9557 | 100.0% |
| Fluid | | | | |
| ND-8 POE Oil | 19.8258 | 19.8736 | 19.8260 | 99.6% |

### OTHER EMBODIMENTS

Embodiment 1: a composition, comprising: i) cis-1,1,1,2,2,5,5,6,6,6-decafluoro-3-hexene ((Z)HFO-153-10mczz); and ii) at least one additional compound; wherein the (Z)HFO-153-10mczz and the at least one additional compound are present in the composition in amounts effective to form an azeotropic composition or an azeotrope-like composition.
Embodiment 2: the composition of embodiment 1, wherein the (Z)HFO-153-10mczz is at least 99% isomerically pure.
Embodiment 3: the composition of embodiment 1, wherein the (Z)HFO-153-10mczz and the at least one additional compound are at least 98%, by weight of the composition.
Embodiment 4: the composition of embodiment 3, wherein the at least one additional compound is selected from the group consisting of trans-1,2-dichloroethylene, perfluoroheptene, ethanol, n-propanol, isopropanol, and combinations thereof.
Embodiment 5: the composition of embodiment 3, wherein the at least one additional compound comprises n-propanol and the composition comprises about 82 to about 98.4% (Z)HFO-153-10mczz and about 1.6 to about 18% n-propanol, by weight of the composition.
Embodiment 6: the composition of embodiment 3, wherein the at least one additional compound comprises n-propanol and the composition comprises about 82 to about 98.4% (Z)HFO-153-10mczz and about 1.6 to about 18% n-propanol, by weight of the composition.
Embodiment 7: the composition of embodiment 3, wherein the at least one additional compound comprises isopropanol and the composition comprises about 76 to about 96% (Z)HFO-153-10mczz and about 4 to about 24% isopropanol, by weight of the composition.
Embodiment 8: the composition of embodiment 3, wherein the composition has a boiling point of about 62° C. to about 70° C. at a pressure of about 101 kPa.
Embodiment 9: the composition of embodiment 3, wherein the at least one additional compound comprises trans-1,2-dichloroethylene and the composition comprises about 17% to about 49% (Z)HFO-153-10mczz and about 51 to about 83 weight percent trans-1,2-chloroethylene by weight of the composition.
Embodiment 10: the composition of embodiment 3, wherein the composition has a boiling point in the range of about 43.5° C. to about 44.5° C. at a pressure of about 101 kPa.
Embodiment 11: the composition of embodiment 3, wherein the at least one additional compound comprises trans-1,2-dichloroethylene and an alcohol selected from the group consisting of ethanol, n-propanol, and isopropanol.
Embodiment 12: the composition of embodiment 11, wherein the composition comprises about 17% to about 35% (Z)HFO-153-10mczz, about 56% to about 79% trans-1,2-dichloroethylene, and about 0.5% to about 15% of the alcohol, by weight of the composition.
Embodiment 13: the composition of embodiment 11, wherein the composition has a boiling point of about 40° C. to about 44° C. at a pressure of about 101 kPa.
Embodiment 14: the composition of embodiment 11, wherein the alcohol is methanol.
Embodiment 15: the composition of embodiment 14, wherein the composition includes about 17% to about 34% (Z)HFO-153-10mczz, about 56% to about 78% t-DCE, and about 2% to about 15% methanol, by weight of the composition.
Embodiment 15: the composition of embodiment 13, wherein the composition has a boiling point of about 39.8° C. to about 40.3° C. at a pressure of about 101 kPa.
Embodiment 17: the composition of embodiment 11, wherein the alcohol is ethanol.
Embodiment 18: the composition of embodiment 17, wherein the composition includes about 19% to about 34% (Z)HFO-153-10mczz, about 60% to about 79% t-DCE, and about 1% to about 7% ethanol, by weight of the composition.
Embodiment 19: the composition of embodiment 17, wherein the composition has a boiling point of about 42.6° C. to about 43.1° C. at a pressure of about 101 kPa.
Embodiment 20: the composition of embodiment 11, wherein the alcohol is isopropanol.
Embodiment 21: the composition of embodiment 20, wherein the composition includes about 19% to about 35% (Z)HFO-153-10mczz, about 63% to about 79% t-DCE, and about 0.5% to about 4% isopropanol, by weight of the composition.
Embodiment 22: the composition of embodiment 20, wherein the composition has a boiling point of about 43.8° C. to about 44.2° C. at a pressure of about 101 kPa.
Embodiment 23: a process of coating a surface, comprising: dissolving a coating composition in a carrier fluid, the carrier fluid comprising cis-1,1,1,2,2,5,5,6,6,6-decafluoro-3-hexene ((Z)HFO-153-10mczz), to form a solution; applying the solution to the surface; and removing the carrier fluid from the coating composition to coat the surface with the coating composition.
Embodiment 24: the process of embodiment 23, wherein the (Z)HFO-153-10mczz is at least 99% isomerically pure.
Embodiment 25: the process of embodiment 23, wherein the coating composition comprises a perfluoropolyether.
Embodiment 26: the process of embodiment 23, wherein the surface is of a disk of a hard disk drive.
Embodiment 27: the process of embodiment 23, wherein the carrier fluid further comprises at least one additional compound, and wherein the (Z)HFO-153-10mczz and the at least one additional compound are present in the carrier fluid in amounts effective to form an azeotropic composition or an azeotrope-like composition.
Embodiment 28: the process of embodiment 27, wherein the at least one additional compound is selected from the group consisting of trans-1,2-dichloroethylene, perfluoroheptene, ethanol, n-propanol, isopropanol, and combinations thereof.
Embodiment 31: the process of embodiment 27, wherein the at least one additional compound comprises trans-1,2-dichloroethylene and an alcohol selected from the group consisting of ethanol, n-propanol, and isopropanol.
Embodiment 32: the process of embodiment 27, wherein the carrier fluid has a boiling point of about 62° C. to about 70° C. at a pressure of about 101 kPa.
Embodiment 31: the process of embodiment 27, wherein the carrier fluid has a boiling point of about 40° C. to about 44° C. at a pressure of about 101 kPa.
Embodiment 32: A process for cooling an electrical component comprising at least partially immersing an electrical component in a working fluid; and transferring heat from the electrical component using the working fluid wherein the working fluid comprises cis-1,1,1,2,2,5,5,6,6,6-decafluoro-3-hexene ((Z)HFO-153-10mczz) and at least one additional compound, wherein the (Z)HFO-153-10mczz and the at least one additional compound are present in the coolant in amounts effective to form an azeotropic composition or an azeotrope-like composition.
Embodiment 33: the process of embodiment 32, wherein the (Z)HFO-153-10mczz is at least 99% isomerically pure.
Embodiment 34: the process of embodiment 32, wherein the coolant further comprises at least one additional compound, and wherein the (Z)HFO-153-10mczz and the at least one additional compound are present in the coolant in amounts effective to form an azeotropic composition or an azeotrope-like composition.
Embodiment 35: the process of embodiment 34, wherein the at least one additional compound is selected from the group consisting of trans-1,2-dichloroethylene, perfluoroheptene, ethanol, n-propanol, isopropanol, and combinations thereof.
Embodiment 36: the process of embodiment 34, wherein the at least one additional compound comprises trans-1,2-dichloroethylene and an alcohol selected from the group consisting of ethanol, n-propanol, and isopropanol.
Embodiment 37: the process of embodiment 34, wherein the coolant has a boiling point of about 62° C. to about 70° C. at a pressure of about 101 kPa.
Embodiment 38: the process of embodiment 34, wherein the coolant has a boiling point of about 40° C. to about 44° C. at a pressure of about 101 kPa.
Embodiment 39: a process of cleaning a surface, comprising contacting a composition with said surface, the composition comprising cis-1,1,1,2,2,5,5,6,6,6-decafluoro-3-hexene ((Z)HFO-153-10mczz) and at least one additional compound, wherein the (Z)HFO-153-10mczz and the at least one additional compound are present in the composition in amounts effective to form an azeotropic composition or an azeotrope-like composition.
Embodiment 408: the process of embodiment 39, wherein the (Z)HFO-153-10mczz is at least 99% isomerically pure.
Embodiment 41: the process of embodiment 39, wherein the composition further comprises at least one additional compound, and wherein the (Z)HFO-153-10mczz and the at least one additional compound are present in the composition in amounts effective to form an azeotropic composition or an azeotrope-like composition.
Embodiment 42: the process of embodiment 41, wherein the at least one additional compound is selected from the group consisting of trans-1,2-dichloroethylene, perfluoroheptene, ethanol, n-propanol, isopropanol, and combinations thereof.
Embodiment 43: the process of embodiment 41, wherein the at least one additional compound comprises trans-1,2-dichloroethylene and an alcohol selected from the group consisting of ethanol, n-propanol, and isopropanol.
Embodiment 44: the process of embodiment 41, wherein the composition has a boiling point of about 62° C. to about 70° C. at a pressure of about 101 kPa.
Embodiment 45: the process of embodiment 41, wherein the composition has a boiling point of about 40° C. to about 44° C. at a pressure of about 101 kPa.
Embodiment 46: the process of embodiment 39, wherein prior to said step of contacting, the surface is coated with a contaminant selected from mineral oil, hydraulic fluid, ND-8 POE oil, and mixtures thereof, and wherein said step of contacting results in removal of amounts of the contaminant.

All above-mentioned references are hereby incorporated by reference herein.

It is to be understood that while the invention has been described in conjunction with the detailed description thereof, the foregoing description is intended to illustrate and not limit the scope of the invention, which is defined by the scope of the appended claims. Other aspects, advantages, and modifications are within the scope of the following claims. It should be appreciated by those persons having ordinary skill in the art(s) to which the present invention relates that any of the features described herein in respect of any particular aspect and/or embodiment of the present invention can be combined with one or more of any of the other features of any other aspects and/or embodiments of the present invention described herein, with modifications as appropriate to ensure compatibility of the combinations. Such combinations are considered to be part of the present invention contemplated by this disclosure.

What is claimed is:

1. A composition, comprising:
i) cis-1,1,1,2,2,5,5,6,6,6-decafluoro-3-hexene ((Z)HFO-153-10mczz); and
ii) at least one additional compound;
wherein the (Z)HFO-153-10mczz and the at least one additional compound are present in the composition in amounts effective to form an azeotropic composition or an azeotrope-like composition.

2. The composition of claim 1, wherein the (Z)HFO-153-10mczz is at least 99% isomerically pure.

3. The composition of claim 1, wherein the (Z)HFO-153-10mczz and the at least one additional compound are at least 98%, by weight of the composition.

4. The composition of claim 3, wherein the at least one additional compound is selected from the group consisting of trans-1,2-dichloroethylene, perfluoroheptene, ethanol, n-propanol, isopropanol, and combinations thereof.

5. The composition of claim 4, wherein the at least one additional compound comprises ethanol and the composition comprises about 71% to about 95% (Z)HFO-153-10mczz and about 5 to about 29 weight percent ethanol, by weight of the composition.

6. The composition of claim 4, wherein the at least one additional compound comprises n-propanol and the composition comprises about 82 to about 98.4% (Z)HFO-153-10mczz and about 1.6 to about 18% n-propanol, by weight of the composition.

7. The composition of claim 4, wherein the at least one additional compound comprises isopropanol and the composition comprises about 76 to about 96% (Z)HFO-153-10mczz and about 4 to about 24% isopropanol, by weight of the composition.

8. The composition of claim 7, wherein the composition has a boiling point of about 62° C. to about 70° C. at a pressure of about 101 kPa.

9. The composition of claim 4, the at least one additional compound comprises trans-1,2-dichloroethylene and the composition comprises about 17% to about 49% (Z)HFO-153-10mczz and about 51 to about 83 weight percent trans-1,2-chloroethylene by weight of the composition.

10. The composition of claim 9, wherein the composition has a boiling point in the range of about 43.5° C. to about 44.5° C. at a pressure of about 101 kPa.

11. The composition of claim 4, wherein the at least one additional compound comprises trans-1,2-dichloroethylene and an alcohol selected from the group consisting of ethanol, n-propanol, and isopropanol.

12. The composition of claim 11, wherein the composition comprises about 17% to about 35% (Z)HFO-153-10mczz, about 56% to about 79% trans-1,2-dichloroethylene, and about 0.5% to about 15% of the alcohol, by weight of the composition.

13. The composition of claim 12, wherein the composition has a boiling point of about 40° C. to about 44° C. at a pressure of about 101 kPa.

14. A process of coating a surface, comprising:
dissolving a coating composition in a carrier fluid, the carrier fluid comprising cis-1,1,1,2,2,5,5,6,6,6-decafluoro-3-hexene ((Z)HFO-153-10mczz), to form a solution;
applying the solution to the surface; and
removing the carrier fluid from the coating composition to coat the surface with the coating composition.

15. The process of claim 14, wherein the (Z)HFO-153-10mczz is at least 99% isomerically pure.

16. The process of claim 14, wherein the carrier fluid further comprises at least one additional compound, and wherein the (Z)HFO-153-10mczz and the at least one additional compound are present in the carrier fluid in amounts effective to form an azeotropic composition or an azeotrope-like composition.

17. The process of claim 16, wherein the at least one additional compound is selected from the group consisting of trans-1,2-dichloroethylene, perfluoroheptene, ethanol, n-propanol, isopropanol, and combinations thereof.

18. The process of claim 14, wherein the coating composition comprises a perfluoropolyether.

19. The process of claim 14, wherein the surface is of a disk of a hard disk drive.

20. A process for cooling an electrical component comprising:
at least partially immersing an electrical component in a working fluid; and
transferring heat from the electrical component using the working fluid;
wherein the working fluid comprises (Z)HFO-153-10mczz.

21. The process of claim 20, wherein the (Z)HFO-153-10mczz is at least 99% isomerically pure.

22. The process of claim 20, wherein the coolant further comprises at least one additional compound, and wherein the (Z)HFO-153-10mczz and the at least one additional compound are present in the coolant in amounts effective to form an azeotropic composition or an azeotrope-like composition.

23. The process of claim 22, wherein the at least one additional compound is selected from the group consisting of trans-1,2-dichloroethylene, perfluoroheptene, ethanol, n-propanol, isopropanol, and combinations thereof.

24. A process of cleaning a surface, comprising contacting a composition with said surface, the composition comprising cis-1,1,1,2,2,5,5,6,6,6-decafluoro-3-hexene ((Z)HFO-153-10mczz).

25. The process of claim 24, wherein the (Z)HFO-153-10mczz is at least 99% isomerically pure.

26. The process of claim 24, wherein the composition further comprises at least one additional compound, and wherein the (Z)HFO-153-10mczz and the at least one additional compound are present in the composition in amounts effective to form an azeotropic composition or an azeotrope-like composition.

27. The process of claim 26, wherein the at least one additional compound is selected from the group consisting of trans-1,2-dichloroethylene, perfluoroheptene, ethanol, n-propanol, isopropanol, and combinations thereof.
